(19) United States
(12) Patent Application Publication
(10) Pub. No.: US 2008/0047173 A1
(43) Pub. Date: Feb. 28, 2008

(54) Greeting card apparatus and method

(76) Inventor: Richard Wilen, Deerfield Beach, FL (US)

Correspondence Address: Stephen E. Feldman, 7th FL, 12 East 41st Street, New York, NY, 10017, US

(21) Appl. No.: 11/502,644

(22) Filed: Aug. 11, 2006

(51) Int. Cl. G09F 1/00

(52) U.S. Cl. 40/124.06

(57) ABSTRACT

A gift card apparatus is described that includes a gift representation and a greeting card. The gift representation can include a product stamp, a gift certificate or a gift debit card. The gift representation is concealed beneath a removable panel that is attached to the first page. A second page retains the greeting card. A method of using the gift card apparatus includes selecting a gift from a list of items provided by a plurality of vendors. The gift item is identified to a gift recipient using a gift representation. The gift giver forwards the gift card apparatus including the gift representation with a greeting card to the gift recipient. The gift representation can include a merchandise certificate with an image of the gift item, a monetary gift certificate and/or a gift credit card. The gift recipient redeems the gift representation using one or more vendors and can select an alternative gift item from the list of items provided by the plurality of vendors.

### FIELD OF THE INVENTION

The present invention relates to apparatuses and methods for gift cards and more specifically to apparatuses and methods for the giving and redeeming of gift cards.

### BACKGROUND OF THE INVENTION

Greeting cards that enclose a conventional plastic gift debit card are often printed in colors appropriate for a particular holiday or celebration and include the trademark for a given store. The purchaser of the gift card needs to make an investment of time to make the trip to the store and endure waiting in line to purchase the gift debit card. While these gift cards are welcome they lack the personalization, element of entertainment, flexibility and surprise that is appropriate for many occasions. Further, the gift debit cards frequently limit the receiver to that one particular business when others may be more attractive.

Greeting cards, in contrast, can be a source of support, humor and pleasant memories, but can often lack the ability to retain a gift card. Store bought greeting cards provide a full spectrum of greetings, but lack the personalization that can be provided by modern conveniences.

A gift card is needed that combines an apparatus and method for use in a novel combination of a greeting card and a gift card that provides the flexibility and personalization desired by consumers.

### SUMMARY OF THE INVENTION

A gift card apparatus is disclosed that comprises a front cover and a back cover that are connected by a fold. A first page includes a panel and a first attachment mechanism. The panel has a first position that is connected to the first page and conceals a gift representation. In a second position of the panel, the gift representation is revealed. The attachment mechanism retains the gift representation between the panel and the first page. A second page is opposed to the first page and includes a removable greeting card. The greeting card is connected to the second page by a second attachment mechanism. A third page and an opposed fourth page provide instructions to a gift recipient on the redemption process for the gift representation. The instructions are optionally provided on at least one of the pages. An optional fifth page and a sixth page that can include guidance, rules and regulations for a gift giver and the gift recipient.

The panel includes perforated edges that allow the panel to rotate from concealing the gift representation to revealing the gift representation. An inset is removably connected to the panel by perforations. The panel has an obverse side that has a decorative format.

The reverse side of the inset includes a transaction record form. The second attachment mechanism is at least one slot. The gift representation includes at least one of a product stamp that has an image of a gift item, a gift certificate that has a defined monetary value or a gift debit card that has a defined monetary value.

A method for using a gift card apparatus comprising the steps of providing a gift card apparatus that receives a gift representation; selecting a gift item from a list of items provided by vendors, or a monetary value; ordering the gift item; identifying the gift item to the gift recipient using a product stamp as a gift representation; positioning the gift representation in the gift card apparatus; forwarding the gift card to the gift recipient; and selecting at least one of redeeming the gift representation through the vendor of the gift representation or redeeming the gift representation for an alternative gift item from any of the vendors;

The steps for using a gift card apparatus can further include the step of preparing a greeting card for the gift recipient. The step of positioning can further include positioning a greeting card in the gift card apparatus. The step of identifying can further include the product stamp gift representation including an image of the gift item. The step of redeeming can include selecting an alternative gift item from a vendor that was different from the vendor of the gift item, or in some cases a monetary value.

The step of identifying can include a gift giver doing at least one of printing out the product stamp on a local printer or separating the product stamp from a catalog. The step of positioning can include positioning at least one of the product stamp, a gift certificate and a gift debit card. The step of redeeming can include notifying the gift giver that the gift recipient has redeemed the gift representation. The step of ordering can include at least one of ordering a gift item by telephone, using an internet connection to a designated web site and visiting a vendor. The step of selecting and redeeming the gift representation for an alternative gift item includes selecting the alternative gift item from the list of items.

### BRIEF DESCRIPTION OF THE DRAWINGS

Preferred embodiments of the invention are described below with reference to the drawings, wherein like numerals are used to refer to the same or similar elements.

FIG. 1 is a top frontal perspective view of one embodiment of the present disclosure of a gift card apparatus that includes a gift card and a gift card mailer;

FIG. 2 is a plan view of a first page and an opposed second page of the gift card of FIG. 1;

FIG. 3 is a plan view of the gift card of FIG. 1 that shows the first page folded open and the second page partially turned to show a third page, an opposed fourth page and a portion of a sixth page of the gift card of FIG. 1; and

FIG. 4 is a simplified schematic of the method for using the gift card apparatus of FIG. 1.

### DETAILED DESCRIPTION

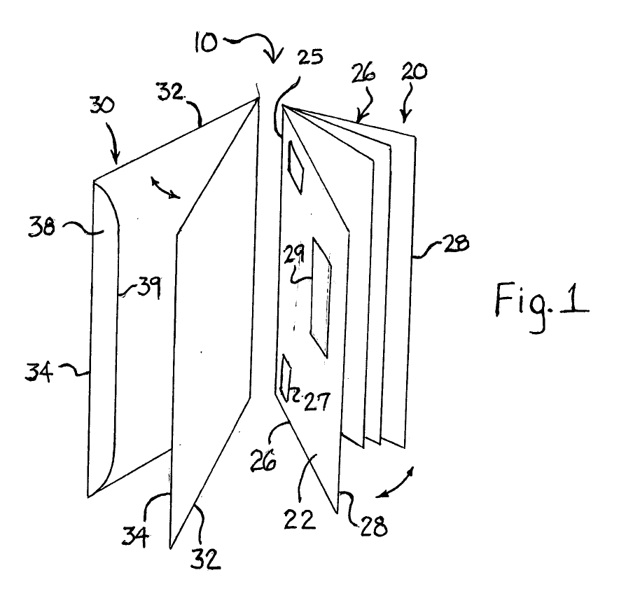

Referring to FIG. 1, the preferred embodiment of a gift card apparatus 10 includes a gift card 20 and an optional gift card mailer 30. Gift card 20 includes a front cover 22 and a back cover (not shown) that are connected by a fold 25. Gift card 20 has opposed first and second edges 26 that are side edges in this preferred embodiment and opposed third and fourth edges 28 that are top and bottom edges, respectively in this embodiment. When gift card 20 is in a first or closed position, only front cover 22, the outer side of fold 25 and the back cover are in view.

Front cover 22 can have one or more decorative formats and further include designated areas 27 and 29 that can include for example the terms “From:” and “To:,” respectively, to identify the giver and recipient of gift card 20. Areas 27 and 29 can be distinguished by color differentiations, fanciful borders and other ways to highlight the giver and recipient of gift card 20. Front cover 22 can also include an area designated for receiving a postage stamp.

In the preferred embodiment, gift card mailer or envelope 30 receives and encloses gift card 20 in the first position. Envelope 30 has opposed first and second edges 32 as well as opposed top and bottom edges 34. A border area 36 in proximity to at least one of the side edges 32 includes an adhesive such as a pressure-sensitive glue to bond sides 32 of envelope 30. Top edge 34 preferably includes a foldable extension or flap 38 that has an adhesive on the inner side in proximity to an edge 39 of flap 38 that is received by the area in proximity to bottom edge 34. Gift card 20 can be slid into envelope 30 through the opening defined by top and bottom edges 34. Envelope 30 can includes decorative formats and words or terms as described for front cover 22. Envelope 30 can be used as a mailer or as gift enclosure that is preassembled or connected together.

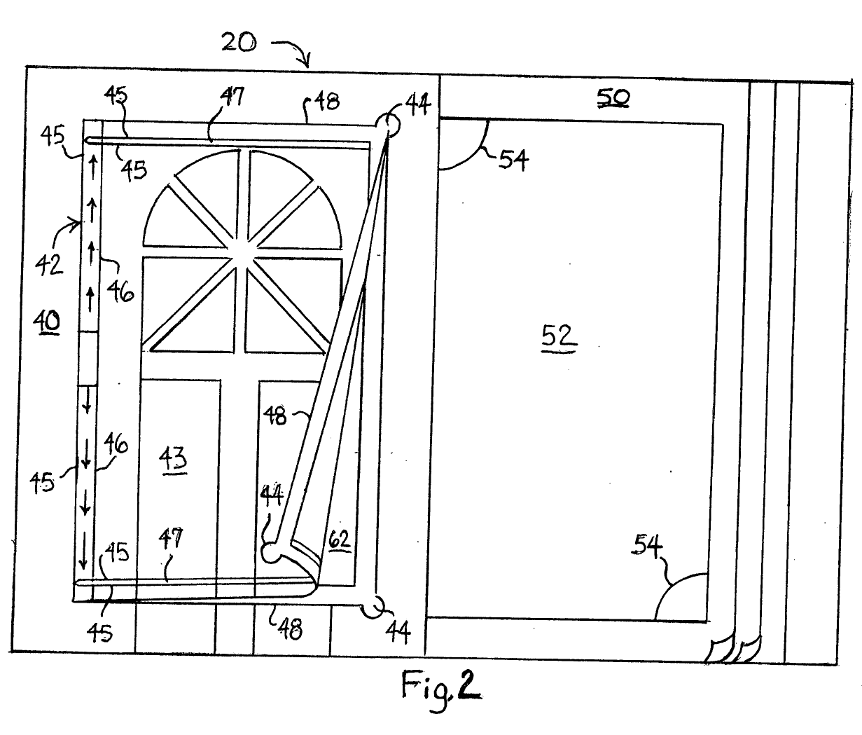

As shown in FIGS. 1 and 2, first page 40 has a first panel 42 that includes an inset 43, at least one tab 44 and a plurality of lines 45, 46 and 48. The at least one tab 44 provides an area that can be readily grasped to assist in the separation of the perforated first panel 42 from first page 40. The plurality of lines 45, 46 and 48 are configured for ease of separation and are at least partially perforated or indented, for example.

In this preferred embodiment, the plurality of lines 48 assists in the separation of panel 42 from first page 40. Line 46 provides a fold for the separate movement of the partially separated first panel 42 relative to first page 40. The plurality of lines 45 assists in the separation of inset 43 from first panel 42. In one preferred embodiment, a plurality of detachable segments 47 are defined between lines 45 that separate inset 43 from panel 42. Written directions for the preferred process for the removal of inset 43 can be printed directly on first page 40 and can include graphics such as arrows on detachable segments 47.

First page 40 preferably has an obverse side with a decorative format that extends across panel 42 and inset 43. In this preferred embodiment, the obverse side has the appearance of a door including door panels, windows and a door handle or any opening. It is understood, however, that first page 40 can include any number of decorative formats to include, for example, a gift wrapped box, photographic images, graphics and words.

Second page 50 includes a greeting card 52 that is retained by a retention mechanism such as slots 54. In this preferred embodiment, slots 54 receive two opposed corners of greeting card 52. Each greeting card 52 can be tailored for the occasion of gift card 20 and can include words, images and/or graphics.

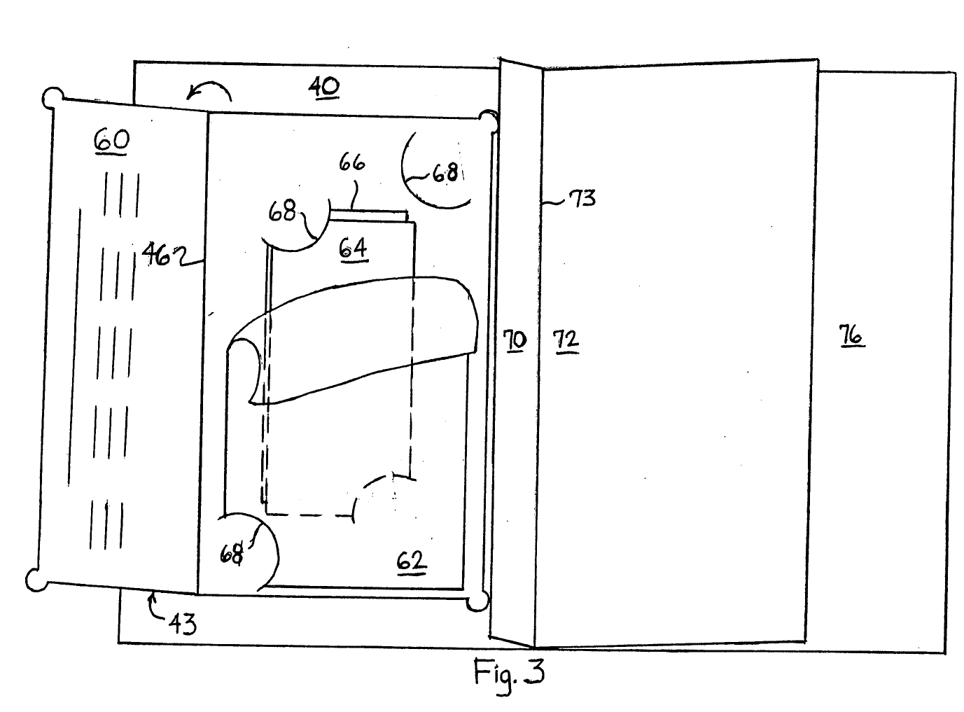

Referring now to FIG. 3, inset 43 has rotated about line 46 to show a reverse side 60 that in this preferred embodiment includes a transaction record form that includes headings such as Date, Code No., $Amount, Balance and Note that is printed on inset 43. Multiple blank rows of lines are provided beneath each heading for an entry by the recipient of gift card 20. Reverse side 60 can also include a coding system that can be read by an automated mechanism such as optical, laser or magnetic devices, for example, and/or employ a visually readable code. Reverse side 60 has an adhesive in proximity to edges 48 that removably secures panel 42 to first page 40.

The rotation of panel 42 and/or inset 43 about fold 46 reveals the one or more gift representations connected to first page 40. Gift representations can include a merchandise gift certificate 62, money gift certificate 64 and/or monetary gift card 66. Each gift representation preferably has an approximately rectangular plate shape that is retained against first page 40 by an attachment mechanism. In this preferred embodiment, the attachment mechanism is one or more sets of slots 68 that receive the diagonally opposed corners of the gift representations. It is understood, however, that the attachment mechanism can be any standard technique of fastening the gift representations such as a non-permanent adhesive or fasteners such as clips or tabs. At least two of the opposed corners of a gift representation can be easily inserted behind and retained by slots 68.

Merchandise gift certificates or product stamps 62 preferably include an actual image of the piece of merchandise that is being transferred in the gift giving process. A monetary gift certificate 64 and/or a standard sized gift credit card 66 also preferably include monetary images and/or monetary amounts printed on their surfaces. The gift representations can further include standard sized memory storage devices that can be read on a computer.

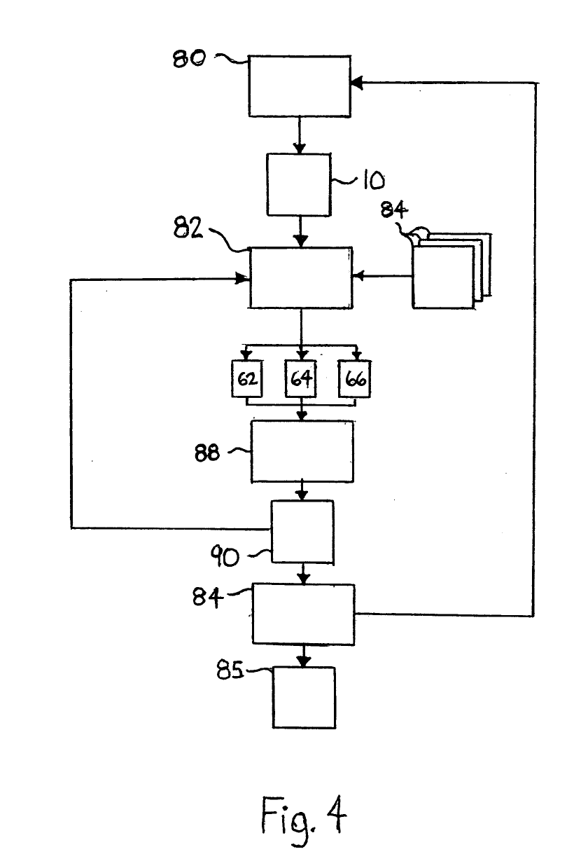

Continuing with FIG. 3, page three 70 and page four 72 of gift card 20 are connected by a fold 73 and preferably provide written instructions for a gift giver 80 and gift recipient 90 (see FIG. 4). These instructions refer the respective giver 80 to a toll free number and web site address for their convenience. Page five (not shown) and page six 76 provide preferably general guidance, rules and regulations for the use of gift card 20 and the gift representations. It is understood that the written instructions and general guidance, rules, and regulations can also be included as separate documents with gift card apparatus 10.

Gift card apparatus 10 is preferably made of flexible paper, but it is understood that apparatus 10 can be made of any material to include polymers. In this preferred embodiment greeting gift card 20 is approximately 5.5 by 7 inches in the first position, panel 42 is approximately 4 by 6 inches and inset 43 is approximately 3.25 by 4.5 inches. The product stamps 62 and monetary gift certificates 64 are preferably approximately 2.8 by 5 inches; the monetary gift cards 66 are preferably approximately 2.1 by 3.2 inches. It is understood that the specific size of the gift representation can vary with the intended application.

As shown in FIGS. 1-4, in operation gift apparatus 10 can be provided to gift givers 80 by any method of distribution. For example, gift apparatuses 10 can be strategically positioned at a check out counter, distributed by mail as a separate product or in conjunction with a catalog that can be recorded on paper or a storage medium such as a CD-ROM, disk, memory card or a memory stick. Included on or with gift apparatus 10 is a website address that identifies a list of items 82 provided by a plurality of vendors 84. Gift card apparatus 10 is a money and merchandising system that uses list of items 82 for the giving of a gift representation such as one or more of a product stamp 62 for merchandise or services, a money gift certificate 64 and a money gift credit card 66.

Vendors 84 that support the use of gift card apparatus 10 can be identified to gift givers 80 via a catalogue that can also be on the internet at a designated web site. Other methods of notification include the posting of a logo at the vendor's place of business or in the vendor's advertisements. Vendors 84 will redeem at least their individual items on list of items 82.

The consumers or gift givers 80 review list of items 82 and select one or more gift items 85 in the form of gift representation 86 that can be for themselves and/or another person. Gift givers 80 then order 88 that gift item 85 using a toll free telephone number or the internet and/or designated website. Making order 88 includes prepaying and registering that product representation using the coding system printed on each gift representation for the corresponding gift item 85. The coding system, as described previously, can be read by an automated mechanism such as optical, laser or magnetic devices, for example, and/or employ a visually readable code for the money and merchandising system including vendors 84.

The product stamp 62 provides a unique advance image of gift item 85 that shows the style, color and particular model selected for a gift recipient 90. Similarly, designated monetary gifts in the form of gift certificate 64 or monetary gift credit card 66 can include personalized logos, pictures symbols and/or messages from gift giver 80 to gift recipient 90.

The gift representation(s) can be selectively separated from a paper catalogue; printed from the internet using a local computer and printer; or called in to a designated preferably toll free telephone number and then received by an alternative method such as by mail, facsimile or e-mail. Similarly, gift giver 80 can select, write, edit and print a greeting card 52 tailored for that specific gift recipient 90 using a standard personal computer system and printer. Gift giver 80 then inserts the gift representation(s), greeting card 52 into gift card 20 and then into envelope 30 for mailing or a personal transfer to gift recipient 90.

When gift apparatus 10 is received by gift recipient 90, the terms of gift card apparatus 10 enables gift recipient 90 to confirm that they desire to receive that particular gift item 85 portrayed by product stamp 62, for example, prior to redeeming product stamp 62. The gift representation can be confirmed or activated at a vendor location, by phone, mail or using the internet at a site designated in gift card 20. As desired, gift item 85 can be received by gift recipient 90 via mail or picked up directly at a vendor's location. Gift giver 80 conveniently receives notice that gift apparatus 10 has been activated via a method previously designated by gift giver 80 such as mail or e-mail.

Gift card apparatus 10 provides gift giver 80 the unique ability to give a gift representation such as a product stamp 62 for a gift item 85 that has been personally selected for that gift recipient 90, a gift certificate for a predetermined value, or a gift credit card for a predetermined value. Gift recipient 90 can confirm, activate and receive that gift item 85 without ever going to the store of that vendor 84 or by going directly to that vendor 84 and activating and redeeming the gift representation.

Gift card apparatus 10 also provides gift recipient 90 with the flexibility to selectively accept the gift representation or choose another gift item 85. The alternative gift item 85 can be chosen from list of items 82, via telephone, internet or directly from visiting one or more vendors 84. When gift recipient 90 has decided on an alternative gift item 85, the new gift representation is activated and received as described above. This provides gift recipient 90 the option of ordering or acquiring 88 an alternative gift item 85 from any vendor 84 for a given gift representation from gift giver 80.

Gift recipient 90 also has the option to upgrade or downgrade the gift item 85 identified by a product stamp 62, for example. This can be done at the site of the vendor 84 of that particular gift item 85 or another vendor 84. Similarly, a product stamp 62 can be converted to an equivalent monetary value via a gift certificate 64 or gift credit card 66. The selection of a lower cost piece of merchandise for gift item 85 can result in a refund of money to gift recipient 90 and an upgrade of product stamp 62 may cost gift recipient 90 additional funds. Thus, apparatus 10 advantageously precludes the undesirable awkwardness of receiving an undesirable gift item 85 and allows gift recipient 90 the ability to flexibly select the gift item 85 color, style and model. This can be done without ever going directly to a vendor 84 or by visiting any one of vendors 84.

In the preceding portion of the specification, the invention has been described with reference to specific exemplary embodiments thereof. It will however, be evident that various modifications, combinations and changes may be made thereto without departing from the broader spirit and scope of the invention as set forth in the claims that follow. For example, the external shape and orientation of gift card apparatus 10 can vary to provide a range of eye catching shapes and the method can still retain the present functions. The specification and drawings are accordingly to be regarded in an illustrative manner rather than a restrictive sense.

What is claimed is:

1. A gift card apparatus that comprises:
a front cover and a back cover connected by a fold;
a first page that includes a rotatable panel and a first attachment mechanism, the panel has a first position that is connected to the first page and conceals a gift representation and the panel rotates to a second position to reveal the gift representation, the attachment mechanism retains the gift representation between the panel and the first page; and
a second page opposed to the first page that includes a removable greeting card, the greeting card connected to the second page by a second attachment mechanism.

2. The gift card apparatus of claim 1, wherein the panel includes perforated edges that allow the panel to rotate from concealing the gift representation.

3. The gift card of claim 1, wherein an inset is removably connected to the panel by perforations.

4. The gift card apparatus of claim 1, wherein an optional fifth page and an optional sixth page opposed to the fifth page, guidance, rules and regulations included for a gift giver and the gift recipient on at least one of the pages.

5. The gift card of claim 3, wherein the inset has an obverse side and a reverse side, the reverse side of the inset includes a transaction record form.

6. The gift card of claim 1, wherein the first attachment mechanism and the second attachment mechanism include at least one pair of opposed slots that receive the gift representations.

7. The gift card of claim 1, wherein the gift representation includes at least one of a product stamp that has an image of a gift item, a gift certificate that has a defined monetary value and a gift credit card that has a defined monetary value.

8. A method for using a gift card apparatus comprising the steps of:
providing a gift card apparatus that receives a gift representation;
selecting a gift item from a list of items provided by vendors;
ordering the gift item;
identifying the gift item to the gift recipient using a gift representation;
positioning the gift representation in the gift card apparatus; and
forwarding the gift card to the gift recipient;
selecting at least one of redeeming the gift representation through a vendor or redeeming the gift representation for an alternative gift item from the list of vendors;

9. The method for using a gift card apparatus of claim 8 that further includes the step of preparing a greeting card for the gift recipient.

10. The method for using a gift card apparatus of claim 9, wherein the step of positioning further includes positioning a greeting card in the gift card apparatus.

11. The method for using a gift card apparatus of claim 8, wherein the step of identifying includes identifying a product stamp gift representation that includes an image of the gift item.

12. The method for using a gift card apparatus of claim 8, wherein the step of redeeming includes selecting an alternative gift item from a vendor that was different from the vendor of the gift item.

13. The method for using a gift card apparatus of claim 8, wherein the step of identifying includes a gift giver identify a gift item by at least one of printing out a product stamp on a local printer or separating the product stamp from a catalog.

14. The method for using a gift card apparatus of claim 8, wherein the step of positioning includes positioning at least one of a product stamp, a monetary gift certificate and a gift credit card.

15. The method for using a gift card apparatus of claim 8, wherein the step of redeeming includes notifying the gift giver that the gift recipient has redeemed the gift representation.

16. The method for using a gift card apparatus of claim 8, wherein the step of ordering includes at least one of ordering a gift item by telephone, using an internet connection to a designated web site and visiting a vendor.

17. The method for using a gift card apparatus of claim 8, wherein the step of selecting and redeeming the gift representation for an alternative gift item includes selecting the alternative gift item from the list of items.

18. The gift card apparatus of claim 1 further comprising:
a third page;
a fourth page opposed to the third page; and
instructions to a gift recipient on the redemption process for the gift representation provided on at least one of the third and fourth pages.
